(19) United States
(12) Patent Application Publication
(10) Pub. No.: US 2022/0169358 A1
(43) Pub. Date: Jun. 2, 2022

(54) LTA Vehicle Launch Configuration and In-Flight Optimization

(71) Applicant: LOON LLC, Mountain View, CA (US)

(72) Inventors: Sameera Sylvia Ponda, Mountain View, CA (US); Beth Ann Reid, Redwood City, CA (US); Justin Garofoli, San Jose, CA (US)

(73) Assignee: LOON LLC, Mountain View, CA (US)

(21) Appl. No.: 17/107,247

(22) Filed: Nov. 30, 2020

(51) Int. Cl. B64B 1/62; B64B 1/40

(52) U.S. Cl. CPC B64B 1/62; B64B 1/70; B64B 1/40

(57) ABSTRACT

The technology described here relates to LTA vehicle launch configuration and in-flight optimization. A method for automated ballast dropping by an LTA vehicle in flight may include receiving, by an in-flight ballast model, an initial lift gas fill amount and an initial ballast amount, generating altitude ranges based on a remaining lift gas amount and a current system mass of the LTA vehicle to determine whether the remaining lift gas amount is within a ballast drop lift gas range, determining whether a convergence criterion for the remaining lift gas amount is met, the convergence criterion indicating a convergence between a remaining lift gas estimate and a remaining lift gas model, determining that dropping a ballast increment will not decrease an overall ballast amount below a target ballast amount corresponding to the remaining lift gas amount, and causing the LTA vehicle to drop the ballast increment.

### BACKGROUND OF INVENTION

Lighter-than-air (LTA) vehicles are being deployed for many different types of missions and purposes, including providing data connectivity (e.g., broadband and other wireless services), weather observations, Earth observations, cargo transport, and more. Different missions entail different objectives, including different expected vehicle lifetimes, altitude ranges, climates traveled. Conventional methods for launch configurations of LTA vehicles are inefficient, necessarily making conservative assumptions about thermal dynamics and altitude ranges due to difficulties in accurately modeling thermal properties, as well as gas fill amounts and other characteristics of LTA vehicles. Often conventional launch configurations assume one set of launch configurations will work sufficiently for all LTA vehicles or same-type vehicles, without regard to differences in their mission or objectives.

Further, in conventional aerospace, the desirable amount of ballast to provide at launch is imprecisely estimated, and ballast dropping for added flight control typically is manually controlled by pilots or flight engineers or based on a fixed schedule, which may not be optimal under varied conditions.

Thus, there is a need for LTA vehicle launch configuration and in-flight optimization.

### BRIEF SUMMARY

The present disclosure provides techniques for LTA vehicle launch configuration and in-flight optimization. A method for automated ballast dropping by an LTA vehicle in flight may include receiving, by an in-flight ballast model, at least an initial lift gas fill amount and an initial ballast amount; generating a plurality of altitude ranges based on a remaining lift gas amount and a current system mass of the LTA vehicle to determine the remaining lift gas amount is within a ballast drop lift gas range; determining, by the in-flight ballast model, whether a convergence criterion for the remaining lift gas amount is met, the convergence criterion indicating a convergence between a remaining lift gas estimate and a remaining lift gas model; determining, by the in-flight ballast model, that dropping a ballast increment will not decrease an overall ballast amount below a target ballast amount corresponding to the remaining lift gas amount; and causing the LTA vehicle to drop the ballast increment. In some examples, generating the plurality of altitude ranges comprises performing a plurality of probabilistic calculations. In some examples, the plurality of probabilistic calculations comprises a Monte Carlo simulation. In some examples, generating the plurality of altitude ranges comprises modeling the plurality of altitude ranges based on the initial lift gas fill amount and the initial ballast amount. In some examples, the plurality of altitude ranges further is based on an initial total mass of the LTA vehicle comprising a base mass and the initial ballast amount. In some examples, the ballast drop lift gas range is based on a comparison between the plurality of altitude ranges for a current system mass of the LTA vehicle with another plurality of altitude ranges for the current system mass minus a ballast increment. In some examples, the target ballast amount is shifted from a prior ballast amount by a predetermined amount based on statistical analysis of noise and oscillation data of lift gas amount estimates. In some examples, the noise and oscillation data comprises actual historical data. In some examples, the noise and oscillation data comprises simulated data. In some examples, the method also includes determining that dropping the ballast increment will not exceed a maximum ballast drop limit. In some examples, the maximum ballast drop limit comprises a daily limit. In some examples, the maximum ballast drop limit comprises a vehicle-specific limit for the LTA vehicle. In some examples, the maximum ballast drop limit comprises a fleet-wide limit for a fleet comprising the LTA vehicle. In some examples, causing the LTA vehicle to drop the ballast increment comprises sending, by the in-flight ballast model, a command to the LTA vehicle.

A distributed computing system for automated ballast dropping by an LTA vehicle in flight may include one or more computers and one or more storage devices, the one or more storage devices storing instructions that when executed cause the one or more computers to implement processors configured to: receive, by an in-flight ballast model, at least an initial lift gas fill amount and an initial ballast amount; generate a plurality of altitude ranges based on a remaining lift gas amount and a current system mass of the LTA vehicle to determine whether the remaining lift gas amount is within a ballast drop lift gas range; determine, by the in-flight ballast model, whether a convergence criterion for the remaining lift gas amount is met, the convergence criterion indicating a convergence between a remaining lift gas estimate and a remaining lift gas model; determine, by the in-flight ballast model, that dropping a ballast increment will not decrease an overall ballast amount below a target ballast amount corresponding to the remaining lift gas amount; and cause the LTA vehicle to drop the ballast increment.

### BRIEF DESCRIPTION OF THE DRAWINGS

FIGS. 1A-1B are diagrams of exemplary operational systems for which ballast and gas fill planning and in-flight optimization may be implemented for an aerial vehicle, in accordance with one or more embodiments;

FIG. 2A is a simplified block diagram of an exemplary computing system forming part of the systems of FIGS. 1A-2, in accordance with one or more embodiments;

FIG. 2B is a simplified block diagram of an exemplary distributed computing system, in accordance with one or more embodiments;

FIG. 3 is a diagram showing an exemplary modeling and estimation flow for vehicle ballast and gas fill planning and in-flight optimization, in accordance with one or more embodiments;

FIG. 4A-4B are charts showing results from models and estimators depicted in FIG. 3, in accordance with one or more embodiments;

FIG. 5A-5C are charts illustrating exemplary frequency plots representing probabilities, in accordance with one or more embodiments;

FIG. 6 is a flow diagram illustrating a method for optimizing for an objective for an LTA vehicle design, in accordance with one or more embodiments; and

FIG. 7 is a flow diagram illustrating a method for automated ballast dropping by an LTA vehicle, in accordance with one or more embodiments.

The figures depict various example embodiments of the present disclosure for purposes of illustration only. One of ordinary skill in the art will readily recognize from the following discussion that other example embodiments based on alternative structures and methods may be implemented without departing from the principles of this disclosure, and which are encompassed within the scope of this disclosure.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The above and other needs are met by the disclosed methods, a non-transitory computer-readable storage medium storing executable code, and systems for dispatching fleets of aircraft by a fleet management and flight planning system. The terms “aerial vehicle” and “aircraft” are used interchangeably herein to refer to any type of vehicle capable of aerial movement, including, without limitation, High Altitude Platforms (HAPs), High Altitude Long Endurance (HALE) aircraft, unmanned aerial vehicles (UAVs), passive lighter than air vehicles (e.g., floating stratospheric balloons, other floating or wind-driven vehicles), powered lighter than air vehicles (e.g., balloons and airships with some propulsion capabilities), fixed-wing vehicles (e.g., drones, rigid kites, gliders), various types of satellites, and other high altitude aerial vehicles.

The invention is directed to techniques for determining setup (i.e., launch) parameters (e.g., gas fill and ballast amount) for lighter-than-air (LTA) vehicles and managing in-flight parameters (e.g., ballast dropping) throughout said LTA vehicle's lifetime to achieve one or more objectives (e.g., maximizing an LTA vehicle's estimated lifespan, maximizing an LTA vehicle's estimated lifespan traveling within a region or along a flight path, maximizing altitude range for a given lifetime of an LTA vehicle, other objectives and combinations thereof). In an example, a lifetime for an LTA vehicle (e.g., superpressure balloon or aerostat) is a length of time (e.g., in days, weeks, months or years) that the LTA vehicle can maintain a positive superpressure (e.g., to maintain altitude and steering ability). The techniques described herein may be used to optimize (e.g., maximize) a lifetime for the LTA vehicle. The terms “lifespan” and “lifetime” are used interchangeably herein to mean an amount of time between a launch and a landing during which an LTA vehicle may have a full set of, or substantial, mission capabilities (e.g., can perform all or most or a threshold amount of missions for said vehicle type, which in some cases may include the full amount of time between the launch and the landing, and also may be related to its ability to access most or all of a steering range (e.g., between a bursting pressure threshold and a zero pressure threshold, which may be set to include a buffer below an actual bursting pressure and above an actual zero pressure)). In another example, these techniques may be used to optimize a steering range for the LTA vehicle (e.g., by tuning an amount of lift gas fill at and during launch, amount of ballast, ballast drop amount and timing, and other parameters). In still another example, a combination of objectives (e.g., lifespan and steering range) are optimized, for example, by determining an amount of lift gas to both achieve a desired lifespan estimate given expected (i.e., estimated) leak rates and maintain an acceptable superpressure (i.e., between a burst pressure threshold and zero pressure threshold) at any altitude within a desired steering range. Ballast may be used to improve probabilities and thresholds for desired objectives.

An LTA vehicle design system may include a thermal model configured to calculate a gas temperature T_{gas} (e.g., expected gas temperature based on prior simulations, gas temperature range based on an expected flight path of the vehicle, a function of ambient temperature (T_{amb}) and supertemperature (ΔT)), a physics model configured to model physics of the LTA vehicle (e.g., determining one or more of a superpressure (ΔP), an amount (i.e., in moles) of lift gas (n_{gas}) and air (nₐᵢᵣ), ambient pressure (P_{amb}), dry system mass (m_{sys}), volume (V), molar mass of lift gas (M_{gas}), and molar mass of air (Mₐᵢᵣ) based on inputs of the other variables, known physical constants, and using the ideal gas law equation and the float equation), and one or more simulation modules configured to model parameters of an LTA vehicle design and launch configuration (e.g., altitude range, gas fill, system mass, total ballast). Lift gas may comprise helium, hydrogen, or any other gas with similar lighter-than-air lift characteristics. In an example, a gas fill estimation module may calculate a gas amount (n_{gas}) and air amount (nₐᵢᵣ) for a balloon (i.e., comprising an outer envelope and a ballonet) or aerostat hull fill. The output n_{gas} and nₐᵢᵣ, along with other characteristics of the LTA vehicle, may be provided as input to a gas leak estimation module (i.e., a Kalman filter or extended Kalman filter) to estimate a leak rate.

In some examples, the above-described system may be used to model aspects of an LTA vehicle's launch configuration (i.e., pre-launch setup) to achieve an objective given various known parameters, including a volume (V) (e.g., in a superpressure balloon envelope, aerostat hull, comprising a ballonet or reverse ballonet configuration) available for lift gas fill, predetermined thresholds for superpressure (ΔP) (e.g., bursting pressure threshold, zero pressure threshold), a mass of the system (i.e., mass of the LTA vehicle, including its balloon or hull, ballast, and payload, with or without lift gas and air), a gas leak rate (i.e., moles per day), a minimum and/or maximum altitude range, and a minimum and/or maximum launch ascent rate (i.e. desired free-lift range). Setup parameters (e.g., an n_{gas} fill amount, a ballast amount at launch) at a range of values may be modeled to determine the parameter value that results in the highest probability of an LTA vehicle achieving the objective or combination of objectives.

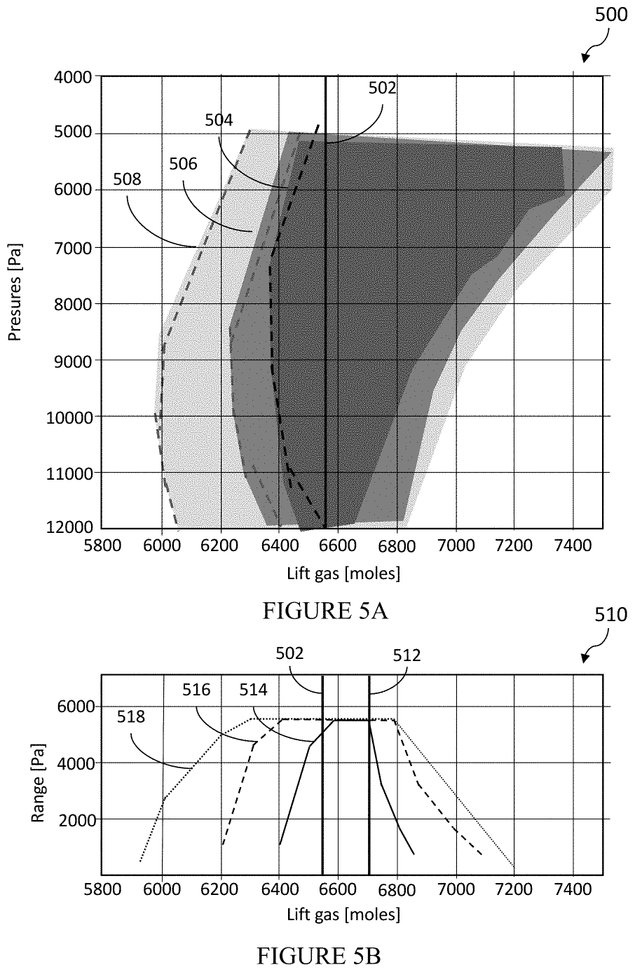

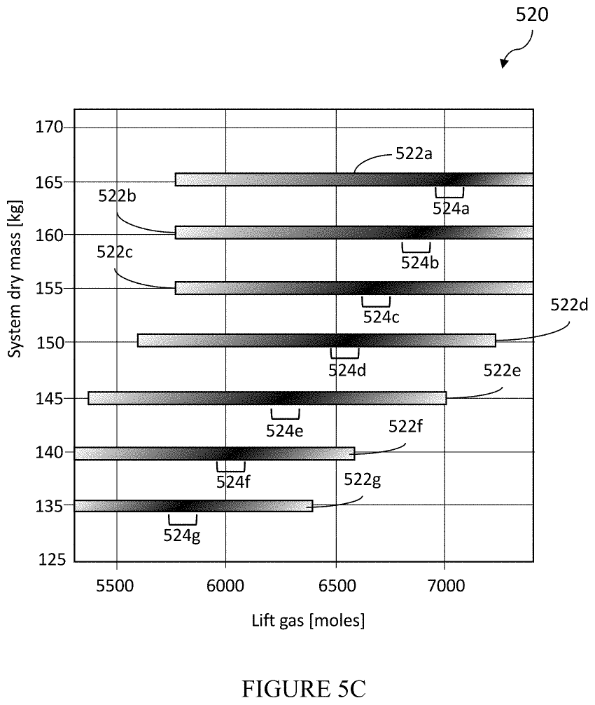

In some examples, such modeling may be accomplished using probabilistic computational algorithms or techniques (e.g., Monte Carlo simulations, ensemble of simulations (e.g., randomized Monte Carlo trial, fixed benchmark of starting conditions representative of an environment), an analytic optimization approach (e.g., a worksheet implementing a set of equations given a set of inputs)). In an example, a Monte Carlo comprising a plurality of simulations may be run to calculate various parameters about an LTA vehicle given an input parameter. Given values for one or more of the parameters above, a Monte Carlo simulation may be configured to output frequency plots for desired objectives (e.g., optimized altitude range, vehicle lifetime expectancy, ability to fly in an expected temperature range for a given amount of time) based on a given set of setup parameters (e.g., n_{gas} fill, total ballast). A plurality of Monte Carlos simulations may be run for different combinations of setup parameters to optimize for a desired objective or combination of objectives. In an example, a frequency plot output by a Monte Carlo may comprise the probability of an LTA vehicle exceeding a burst pressure threshold or falling below a zero-pressure threshold at a plurality of (or all) altitudes within a desired altitude range. A sweep of setup parameters, comprising a combinatorial set of starting n_{gas} and ballast amounts, may be used as an input into the Monte Carlo, and a Monte Carlo may be run for each n_{gas} and ballast combination. The stochastic parameters in the Monte Carlo are the various unknown quantities sampled from modeled distributions (e.g. leak rate, temperature, IR and ambient pressures expected to be encountered during a flight (i.e., in view of given flight path trajectories, weather data over several historic years for said given flight path trajectories, and other data)). Such Monte Carlos may provide frequency plots over ranges of ballast and n_{gas} (e.g., FIGS. 5A-5C), indicating high probabilities (including the highest probability) of maximizing an objective.

Using the same or similar modeling techniques and optimized setup parameters, in-flight parameters also may be dynamically optimized (e.g., ballast drop amount and timing). In an example, ballast drop amount and timing can be automated to ensure optimized steering range for a lifetime of an LTA vehicle. Steering range depends on vehicle mass and remaining n_{gas}, which begins to decrease (i.e., primarily from leakage) after vehicle launch. Estimates of remaining n_{gas} (e.g., based on sensor measurements of ambient pressure, superpressure, gas temperature, etc.) can be noisy, and ballast cannot be reclaimed once dropped, so an automated ballast dropping system may be configured to drop ballast only after a convergence criterion for remaining n_{gas} is met (e.g., convergence of modeled and estimated remaining n_{gas}). In some examples, a shift in overall target ballast amount by a predetermined amount (e.g., 1 kg, 2 kg, 3 kg, or more, less or between) may be implemented to further avoid premature dropping of ballast. The predetermined amount may be determined based on statistical analysis of simulated and/or actual historical noise and oscillation data of remaining n_{gas} estimates.

In some examples, a launch ballast also may be provided at launch to slow down ascent rates during launch and to achieve a target free lift or target ascent rate. Once the LTA vehicle reaches float, this launch ballast may be discarded, and the remaining ballast managed (i.e., dropped) according to methods described herein.

Example Systems

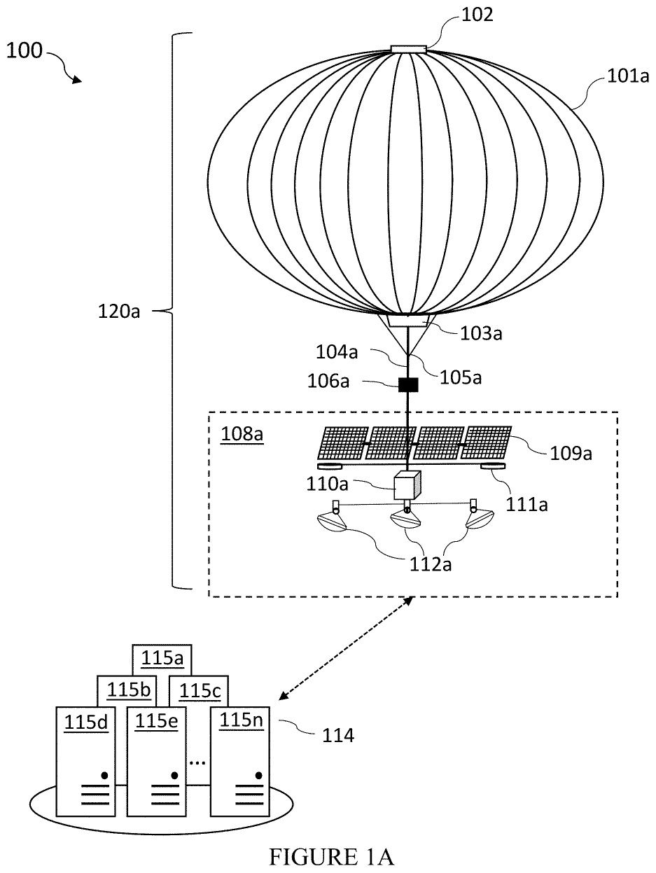

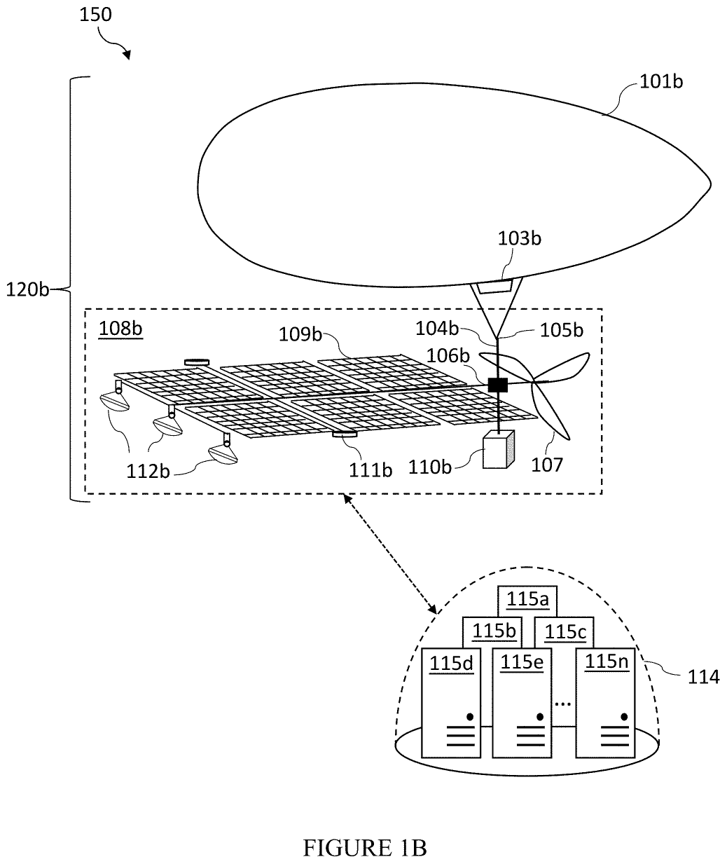

FIGS. 1A-1B are diagrams of exemplary operational systems for which ballast and gas fill planning and in-flight optimization may be implemented for an aerial vehicle, in accordance with one or more embodiments. In FIG. 1A, there is shown a diagram of system 100 for launch and control of aerial vehicle 120a. In some examples, aerial vehicle 120a may be a passive vehicle, such as a balloon or satellite, wherein most of its directional movement is a result of environmental forces, such as wind and gravity. In other examples, aerial vehicles 120a may be actively propelled. In an embodiment, system 100 may include aerial vehicle 120a and ground station 114. In this embodiment, aerial vehicle 120a may include balloon 101a, plate 102, altitude control system (ACS) 103a, connection 104a, joint 105a, actuation module 106a, and payload 108a. In some examples, plate 102 may provide structural and electrical connections and infrastructure. Plate 102 may be positioned at the apex of balloon 101a and may serve to couple together various parts of balloon 101a. In other examples, plate 102 also may include a flight termination unit, such as one or more blades and an actuator to selectively cut a portion and/or a layer of balloon 101a. In other examples, plate 102 further may include other electronic components (e.g., a sensor, a part of a sensor, power source, communications unit). ACS 103a may include structural and electrical connections and infrastructure, including components (e.g., fans, valves, actuators, etc.) used to, for example, add and remove air from balloon 101a (i.e., in some examples, balloon 101a may include an interior ballonet within its outer, more rigid shell that may be inflated and deflated), causing balloon 101a to ascend or descend, for example, to catch stratospheric winds to move in a desired direction. Balloon 101a may comprise a balloon envelope comprised of lightweight and/or flexible latex or rubber materials (e.g., polyethylene, polyethylene terephthalate, chloroprene), tendons (e.g., attached at one end to plate 102 and at another end to ACS 103a) to provide strength and stability to the balloon structure, and a ballonet, along with other structural components. In various embodiments, balloon 101a may be non-rigid, semi-rigid, or rigid.

Connection 104a may structurally, electrically, and communicatively, connect balloon 101a and/or ACS 103a to various components comprising payload 108a. In some examples, connection 104a may provide two-way communication and electrical connections, and even two-way power connections. Connection 104a may include a joint 105a, configured to allow the portion above joint 105a to pivot about one or more axes (e.g., allowing either balloon 101a or payload 108a to tilt and turn). Actuation module 106a may provide a means to actively turn payload 108a for various purposes, such as improved aerodynamics, facing or tilting solar panel(s) 109a advantageously, directing payload 108a and propulsion units (e.g., propellers 107 in FIG. 1B) for propelled flight, or directing components of payload 108a advantageously.

Payload 108a may include solar panel(s) 109a, avionics chassis 110a, broadband communications unit(s) 111a, and terminal(s) 112a. Solar panel(s) 109a may be configured to capture solar energy to be provided to a battery or other energy storage unit, for example, housed within avionics chassis 110a. Avionics chassis 110a also may house a flight computer (e.g., computing device 301, as described herein), a transponder, along with other control and communications infrastructure (e.g., a controller comprising another computing device and/or logic circuit configured to control aerial vehicle 120a). Communications unit(s) 111a may include hardware to provide wireless network access (e.g., LTE, fixed wireless broadband via 5G, Internet of Things (IoT) network, free space optical network or other broadband networks). Terminal(s) 112a may comprise one or more parabolic reflectors (e.g., dishes) coupled to an antenna and a gimbal or pivot mechanism (e.g., including an actuator comprising a motor). Terminal(s) 112(a) may be configured to receive or transmit radio waves to beam data long distances (e.g., using the millimeter wave spectrum or higher frequency radio signals). In some examples, terminal(s) 112a may have very high bandwidth capabilities. Terminal(s) 112a also may be configured to have a large range of pivot motion for precise pointing performance. Terminal(s) 112a also may be made of lightweight materials.

In other examples, payload 108a may include fewer or more components, including propellers 107 as shown in FIG. 1B, which may be configured to propel aerial vehicles 120a-b in a given direction. In still other examples, payload 108a may include still other components well known in the art to be beneficial to flight capabilities of an aerial vehicle. For example, payload 108a also may include energy capturing units apart from solar panel(s) 109a (e.g., rotors or other blades (not shown) configured to be spun, or otherwise actuated, by wind to generate energy). In another example, payload 108a may further include or be coupled to an imaging device, such as a downward-facing camera and/or a star tracker. In yet another example, payload 108a also may include various sensors (not shown), for example, housed within avionics chassis 110a or otherwise coupled to connection 104a or balloon 101a. Such sensors may include Global Positioning System (GPS) sensors, wind speed and direction sensors such as wind vanes and anemometers, temperature sensors such as thermometers and resistance temperature detectors (i.e., RTDs), speed of sound sensors, acoustic sensors, pressure sensors such as barometers and differential pressure sensors, accelerometers, gyroscopes, combination sensor devices such as inertial measurement units (IMUs), light detectors, light detection and ranging (LIDAR) units, radar units, cameras, other image sensors, and more. These examples of sensors are not intended to be limiting, and those skilled in the art will appreciate that other sensors or combinations of sensors in addition to these described may be included without departing from the scope of the present disclosure.

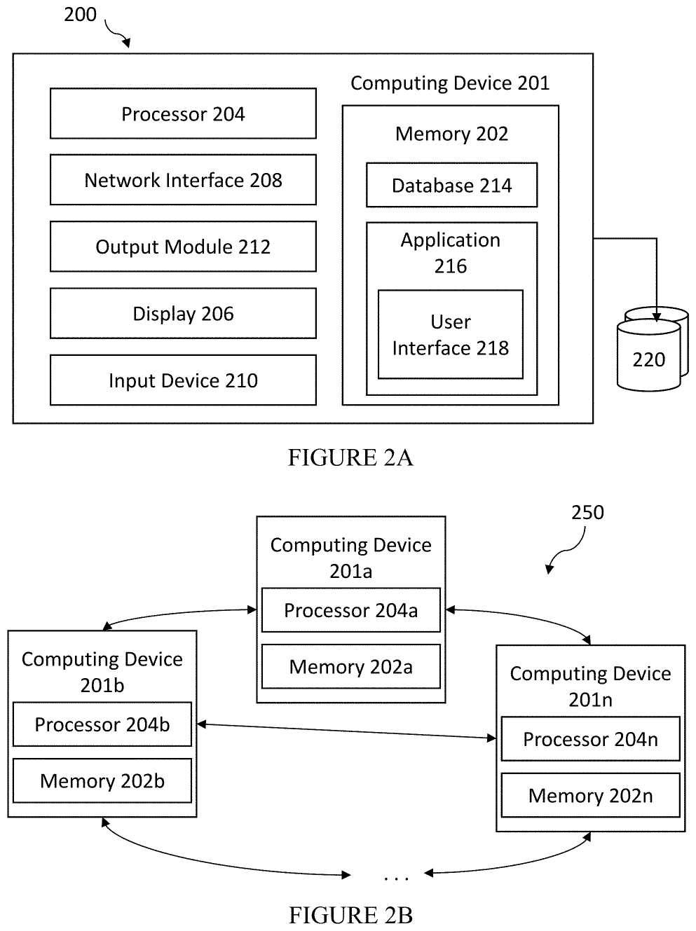

Ground station 114 may include one or more server computing devices 115a-n, which in turn may comprise one or more computing devices (e.g., computing device 201 in FIG. 2). In some examples, ground station 114 also may include one or more storage systems, either housed within server computing devices 115a-n, or separately (see, e.g., computing device 301 and repositories 320). Ground station 114 may be a datacenter servicing various nodes of one or more networks (e.g., an aerial vehicle network, or other mesh network).

FIG. 1B shows a diagram of system 150 for launch and control of aerial vehicle 120b. All like-numbered elements in FIG. 1B are the same or similar to their corresponding elements in FIG. 1A, as described above (e.g., balloon 101a and balloon 101b may serve the same function, and may operate the same as, or similar to, each other). In some examples, balloon 101b may comprise an airship hull or dirigible balloon. In this embodiment, aerial vehicle 120b further includes, as part of payload 108b, propellers 107, which may be configured to actively propel aerial vehicle 120b in a desired direction, either with or against a wind force to speed up, slow down, or re-direct, aerial vehicle 120b. In this embodiment, balloon 101b also may be shaped differently from balloon 101a, to provide different aerodynamic properties. In some examples, balloon 101b may include one or more fins (not shown) coupled to one or more of a rear, upper, lower, or side, surface (i.e., relative to a direction in which balloon 101b is heading).

As shown in FIGS. 1A-1B, aerial vehicles 120a-b may be largely wind-influenced aerial vehicles, for example, balloons carrying a payload (with or without propulsion capabilities) as shown, or fixed wing high altitude drones with gliding and/or full propulsion capabilities. However, those skilled in the art will recognize that the systems and methods disclosed herein may similarly apply and be usable by various other types of aerial vehicles.

FIG. 2A is a simplified block diagram of an exemplary computing system forming part of the systems of FIGS. 1A-2, in accordance with one or more embodiments. In one embodiment, computing system 200 may include computing device 201 and storage system 220. Storage system 220 may comprise a plurality of repositories and/or other forms of data storage, and it also may be in communication with computing device 201. In another embodiment, storage system 220, which may comprise a plurality of repositories, may be housed in one or more of computing device 201. In some examples, storage system 220 may store state data, commands (e.g., flight, navigation, communications, mission, fallback), and other various types of information as described herein. This information may be retrieved or otherwise accessed by one or more computing devices, such as computing device 201 or server computing devices 115a-n in FIGS. 1A-1B, in order to perform some or all of the features described herein. Storage system 220 may comprise any type of computer storage, such as a hard-drive, memory card, ROM, RAM, DVD, CD-ROM, write-capable, and read-only memories. In addition, storage system 220 may include a distributed storage system where data is stored on a plurality of different storage devices, which may be physically located at the same or different geographic locations (e.g., in a distributed computing system such as system 250 in FIG. 2B). Storage system 220 may be networked to computing device 201 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 201 also may include a memory 202. Memory 202 may comprise a storage system configured to store a database 214 and an application 216. Application 216 may include instructions which, when executed by a processor 204, cause computing device 201 to perform various steps and/or functions, as described herein. Application 216 further includes instructions for generating a user interface 218 (e.g., graphical user interface (GUI)). Database 214 may store various algorithms and/or data, including neural networks (e.g., encoding flight policies, as described herein) and data regarding wind patterns, weather forecasts, past and present locations of aerial vehicles (e.g., aerial vehicles 120a-b), sensor data, map information, air traffic information, among other types of data. Memory 202 may include any non-transitory computer-readable storage medium for storing data and/or software that is executable by processor 204, and/or any other medium which may be used to store information that may be accessed by processor 204 to control the operation of computing device 201.

Computing device 201 may further include a display 206, a network interface 208, an input device 210, and/or an output module 212. Display 206 may be any display device by means of which computing device 201 may output and/or display data. Network interface 208 may be configured to connect to a network using any of the wired and wireless short range communication protocols described above, as well as a cellular data network, a satellite network, free space optical network and/or the Internet. Input device 210 may be a mouse, keyboard, touch screen, voice interface, and/or any or other hand-held controller or device or interface by means of which a user may interact with computing device 201. Output module 212 may be a bus, port, and/or other interface by means of which computing device 201 may connect to and/or output data to other devices and/or peripherals.

In some examples computing device 201 may be located remote from an aerial vehicle (e.g., aerial vehicles 120a-b) and may communicate with and/or control the operations of an aerial vehicle, or its control infrastructure as may be housed in avionics chassis 110a-b, via a network. In one embodiment, computing device 201 is a data center or other control facility (e.g., configured to run a distributed computing system as described herein), and may communicate with a controller and/or flight computer housed in avionics chassis 110a-b via a network. As described herein, system 200, and particularly computing device 201, may be used for planning a flight path or course for an aerial vehicle based on wind and weather forecasts to move said aerial vehicle along a desired heading or within a desired radius of a target location. Various configurations of system 200 are envisioned, and various steps and/or functions of the processes described below may be shared among the various devices of system 200 or may be assigned to specific devices.

FIG. 2B is a simplified block diagram of an exemplary distributed computing system, in accordance with one or more embodiments. System 250 may comprise two or more computing devices 201a-n. In some examples, each of 201a-n may comprise one or more of processors 204a-n, respectively, and one or more of memory 202a-n, respectively. Processors 204a-n may function similarly to processor 204 in FIG. 2A, as described above. Memory 202a-n may function similarly to memory 202 in FIG. 2A, as described above.

Example Methods

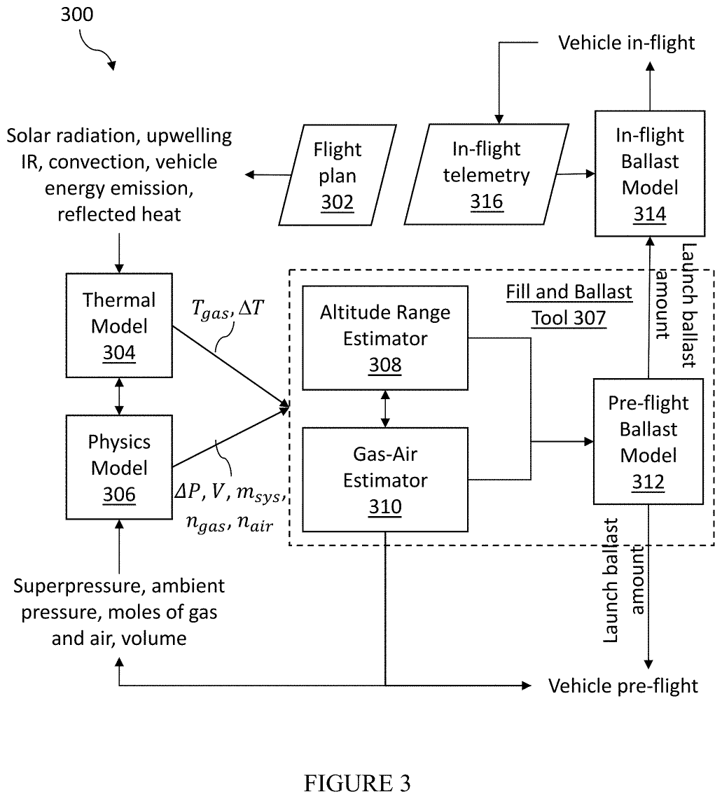

FIG. 3 is a diagram showing an exemplary modeling and estimation flow for vehicle ballast and gas fill planning and in-flight optimization, in accordance with one or more embodiments. Flow 300 may be implemented using any of the computing systems (e.g., system 200 and 250) described herein. Thermal model 304 may be configured to calculate an internal lift gas temperature T_{gas}, which may comprise an expected gas temperature based on prior simulations, a gas temperature range based on an expected flight path of the vehicle, or an in-flight gas temperature estimate given sensor data, and may be a function of ambient temperature (T_{amb}) and supertemperature (ΔT), ΔT being a function of ambient pressure (P_{amb}) and local heat fluxes. In some examples, real-time T_{gas} measurements may be provided by local sensors. In other examples, thermal model 304 may receive one or more inputs related to flight plan 302, in addition to inputs from sensor data (e.g., temperature and pressure sensors), to estimate T_{gas}. Said inputs may be obtained or derived from flight plan 302, as well as other sources, including nowcast and forecast weather services (e.g., National Oceanic and Atmospheric Administration's (NOAA's) Global Forecast System (GFS), European Center for Medium-Range Weather Forecast's (ECMWF's) high resolution forecasts (HRES), and the like), weather observations from weather stations (e.g., stationary, mobile, on the ground, in the air), other databases of historical temperature and heat radiation (e.g., for locations along a route and at destinations indicated by flight plan 302). Such inputs may include, without limitation, solar radiation (qₛᵤₙ), upwelling infrared radiation (IR) (e.g., from Earth (q_{earthIR}), surrounding clouds (g_{cloudIR}), atmosphere or sky (q_{skyIR}), and other sources of infrared radiation, as measured directly by sensors (i.e., during times when sensor measurement confidence levels are higher) or derived from historical data), convection (e.g., internal (film and gas) and external (film and air)), vehicle energy emissions (e.g., black body radiation by a balloon envelope or aerostat hull), and reflected heat. In addition, lift gas temperature sensor readings with sufficient confidence ratings (e.g., lift gas temperature sensor data often is determined to have a sufficient confidence rating for accuracy at night, whereas solar radiation corrupts the sensor readings and the confidence drops, making the estimator rely more heavily on the thermal model inferences) can be combined with thermal model inferences to generate T_{gas} estimates in flight (e.g., real-time). Thermal model 304 may be configured to output a T_{gas} based on one or a combination of said inputs. In some examples, thermal model 304 also may output ΔT, from which T_{amb} may be derived.

Physics model 306 may be configured to model physics of an LTA vehicle, including determining one or more of a superpressure (ΔP), an amount (i.e., in moles) of lift gas and air (n_{gas} and nₐᵢᵣ), ambient pressure (P_{amb}), dry system mass (m_{sys}), volume ((V) (e.g., inside ballonet, envelope or hull), molar mass of lift gas (M_{gas}), and molar mass of air (Mₐᵢᵣ) based on inputs of the other variables, known physical constants, and using the ideal gas law equation and the float equation. Physics model 306 may be configured to output any one or more of these vehicle parameters given other known or pre-determined parameters (e.g., from a vehicle design, pre-flight vehicle setup, or from in-flight sensor data and upstream estimators).

Outputs (e.g., T_{gas}, ΔT, ΔP, V, nₐᵢᵣ, n_{gas}, m_{sys}) of thermal model 304 and physics model 306 may be provided to one or more estimators in a fill and ballast tool 307, including altitude range estimator 308 and gas-air estimator 310. Altitude range estimator 308 and gas-air estimator 310 may use probabilistic computational algorithms or techniques (e.g., Monte Carlo simulations) to model (e.g., simulate or compute) an altitude range and gas and air amounts over the projected flight's lifetime, respectively. Altitude range estimator 308 may be configured to run a Monte Carlo comprising a plurality of simulations using one or more of the vehicle parameters from thermal model 304 and physics model 306. An output of altitude range estimator 308 may comprise a plurality of probabilities of flights of an LTA vehicle that may have one or more altitude ranges given the one or more vehicle parameters (e.g., given pressures, temperatures, lift gas fill amount, system mass). Similarly, gas-air estimator 310 may be configured to run a Monte Carlo comprising a plurality of simulations using one or more of the vehicle parameters as inputs (e.g., from thermal model 304 and/or physics model 306). An output of gas-air estimator 310 may comprise a plurality of probabilities of flights of an LTA vehicle that may have a gas amount and an air amount given said one or more vehicle parameters (e.g., given days in flight, lift gas fill amount, leak rates, temperatures, system mass, pressures). Altitude range estimator 308 and gas-air estimator 310 may also be used in-flight to estimate a flight's current altitude range and lift gas leak rate (e.g. using an Extended Kalman Filter), which can then be used to optimize the vehicle's in-flight ballast configuration. In some examples, the gas-air estimator 310 and physics model 306 may be combined into a physics estimator module (not shown).

Said pluralities of probabilities may be represented graphically (i.e., visually) in various types of frequency plots (e.g., histograms showing probabilities of a vehicle with given parameters exceeding or dropping below pressure thresholds, histograms showing probabilities of a vehicle with given parameters achieving altitude ranges), such as shown in FIGS. 5A-5C. FIG. 5A-5C are charts illustrating exemplary frequency plots representing probabilities resulting from models and estimators depicted in FIG. 3, in accordance with one or more embodiments. For example, FIG. 5A comprises a frequency plot 500 representing the results of a series of Monte Carlos at a given system mass at a range of lift gas fill amounts (i.e., x-axis) showing a percentage of time the simulated vehicle is able to access the desired altitude range, altitude represented on the y-axis as pressure (Pascals). As shown in frequency plot 500, border 504 shows the lift gas amounts at which approximately 97.5% of the time the altitude range is accessible (e.g., without breaching a zero pressure or bursting pressure threshold). Border 506 represents the lift gas amounts at which approximately 95% of the time the altitude range is accessible, and border 508 represents the lift gas amounts at which approximately 90% of the time the altitude range is accessible. Border 504 is shown relative to line 502, which represents a static minimum lift gas, below which at least a fraction (i.e., a small fraction) of vehicles would be expected to be in danger of meeting or exceeding a zero pressure threshold. The static minimum lift gas may be calculated based on a volume (e.g., ballonet, envelope, hull), a system mass, and an amount of gas (e.g., in ballonet, envelope, hull), and a Tᵢₙₜ and Tₑₙᵥ (e.g., resulting in a fixed temperature or T_{diff}).

A frequency plot like frequency plot 500 may be generated for each of a range of vehicle parameters (e.g., a range of vehicle masses, a range of temperatures). A histogram of frequency plots also may be derived from a set of frequency plots for a range of vehicle parameters (e.g., to show median and range of superpressures at which there is an acceptable probability of avoiding zero pressure or bursting pressure thresholds.

In FIG. 5B, a different frequency plot 510 illustrates results of the same set of simulations, but as a function of altitude range on the y-axis. Solid line 514 shows the altitude ranges accessible to a vehicle at a range of lift gas amounts 97.5% of the time. Dashed line 516 shows the altitude ranges accessible to a vehicle at a range of lift gas amounts 95% of the time. Dotted line 518 shows the altitude range accessible to a vehicle at a range of lift gas amounts 90% of the time. Line 502 represents the same static minimum lift gas amount as in frequency plot 500. Line 512 represents a maximum lift gas amount (e.g., to achieve the maximum steering range 97.5% of the time). In some examples, an amount (e.g., percent) of free lift gas (i.e., to produce desired free lift) may correspond to a lift gas amount at float or a maximum lift gas amount that roughly corresponds to line 512.

As described above, each of frequency plots 500 and 510 represents results of simulations for a given vehicle mass. A set of simulations may be run for a range of vehicle masses, the results of which may be graphically represented in a histogram. In FIG. 5C, histogram 520 shows the results for a range of masses (i.e., system dry mass in kg on y-axis). Shaded bars 522a-g each represent a range of lift gas for a respective system dry mass, the shading showing a probability of accessing a desired altitude range (i.e., between a given floor altitude (e.g., between 13-16 km or 12,000-10,000 Pa, or more or less, depending on vehicle characteristics) and a given ceiling altitude (e.g., 18-20 km or 7000-5500 Pa, or more or less, depending on vehicle characteristics)). The optimal lift gas fill range is indicated by the darkest ranges 524a-g for each mass, wherein the probabilities of accessing the desired altitude range are the highest (e.g., in a highest range).

Altitude ranges, gas amounts and air amounts may be used by pre-flight ballast model 312 to optimize for a ballast amount to launch a vehicle with, which may be used in a vehicle's pre-flight design, as well as by in-flight ballast model 314 to determine optimal ballast drop timing and amount. In an example, pre-flight ballast model 314 may receive as inputs one, or a combination, of a base mass (e.g., balloon envelope plus payload, vehicle system mass without ballast and gas fill, which differs from m_{sys} which may include ballast), a maximum ballast mass (i.e., as a limit for pre-flight ballast model 312, which may be limited in some examples by an amount of weight that may be supported by a connection holding a payload and ballast (e.g., connection 104a and 104b)), a ballast increment (e.g., 1.0 kg, 1.5 kg, 2.0 kg, 5.0 kg, or other predetermined or sampled increment), an expected leak rate (e.g., based on simulations and/or historical data for said vehicle type and characteristics), a desired lifetime (e.g., tens or hundreds of days, months, years), and a desired launch free lift percentage, among other inputs. Using such inputs, pre-flight ballast model 312 may be configured to output one, or a combination, of a confirmation of launch mass, a recommended optimal ballast amount (i.e., ballast mass in kg to be provided pre-flight), a recommended launch gas fill (i.e., for the balloon or hull envelope), a recommended launch ballast amount (i.e., to achieve a desired free lift during ascent, which may be dropped soon after an LTA vehicle reaches altitude or during ascent). In another example, fill and ballast tool 307 may receive as inputs one, or a combination, of an expected total mass (i.e., a base mass plus ballast and gas fill), a target lifetime, a target or expected gas leak rate (i.e., moles of gas lost per day), a target fixed launch gas fill, expected ballast amount (e.g., a range from zero to a total or maximum ballast amount). In this example, fill and ballast tool 307 may be configured to output one, or a combination, of a target or expected gas fill amount and one or more ballast amounts (e.g., a minimum target float ballast, a maximum target float ballast, a minimum total ballast). Other outputs may include an expected float pressure, an expected float altitude, an expected free lift (e.g., a function of the target launch gas fill and amount of ballast), and an estimated superpressure at one or more given altitudes (e.g., a minimum and/or maximum threshold altitude). In an example, a target gas fill amount may be determined based on a desired gas fill amount at an end of vehicle life (e.g., determined by Monte Carlo altitude range maximization, assuming zero ballast remaining) plus a target lifetime multiplied by a maximum expected gas leak rate. An optimal amount of ballast may be chosen to optimize an altitude range given the target gas fill value.

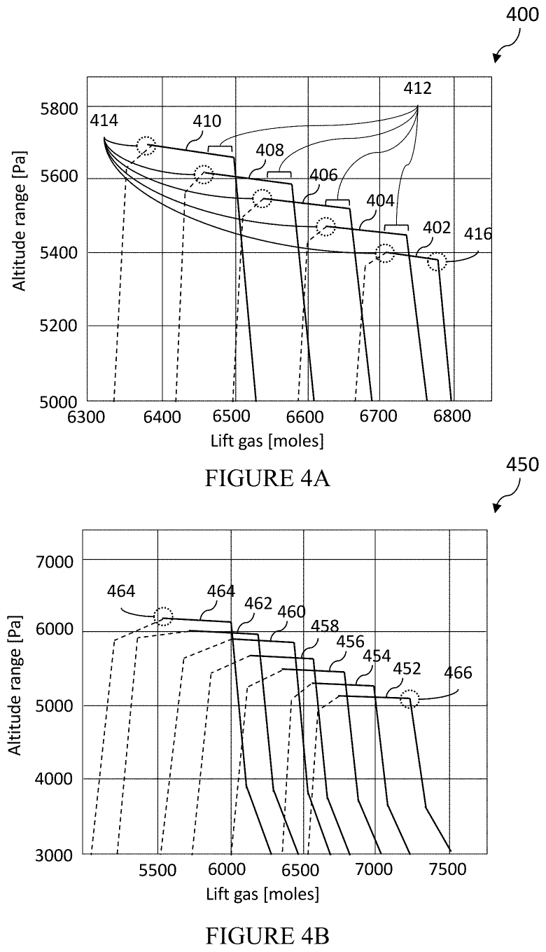

Results of a plurality of simulations performed by fill and ballast tool 307 according to a plurality of input combinations (e.g., with sample increments within a range of base masses and/or different sample ballast increments, along with other predetermined inputs) may be visualized in altitude range charts, such as charts 400 and 450 in FIGS. 4A-4B. For example, altitude range chart 400 shows altitude ranges for a vehicle with a given base mass (e.g., approximately 150 kilograms), a given maximum ballast amount (e.g., 15 kilograms), and a given ballast increment (e.g., 2 kilograms). In an example, pre-flight ballast model 312 may output a recommended optimal ballast amount (e.g., 8 kilograms), a recommended launch gas fill 416 (e.g., approximately 6,770 moles of helium), and altitude ranges for the vehicle at a range of lift gas amounts. Line 402 represents resulting altitude ranges for the vehicle with a total system mass (e.g., approximately 158 kilograms) comprising the base mass and the full optimal ballast amount at a range of lift gas amounts. Line 402 indicates that launching with more than recommended launch gas fill 416 would result in a steep reduction in altitude range, and an expectation of frequent breaches of a pressure threshold (e.g., burst pressure threshold). Similarly line 404 represents resulting altitude ranges for the vehicle with a total system mass (e.g., approximately 156 kilograms) comprising the base mass and ballast amount after a first ballast drop, and so on in 2 kilogram ballast drop increments until line 410 for a total system mass (e.g., approximately 150 kilograms) after all of the optimal ballast amount has been dropped. Cliffs 414 for each of lines 402-410 indicate a gas fill amount at or near a pressure threshold, at which the vehicle is likely to zero pressure. These results recommend ballast drops during ballast drop lift gas ranges 412 where a first optimal altitude range for the vehicle at a current total system mass overlaps with a second optimal altitude range for the next incremental total system mass after a ballast drop, and before the vehicle at the current total system mass reaches its respective cliff 414. The gradual change from the recommended launch gas fill 416 to a first cliff 414 may correspond to a time frame that may be derived from a calculated gas leak rate for the vehicle (e.g., based on historical or simulated data) or from real-time gas leak data (e.g. for in-flight ballast optimization). The time frame for the vehicle to exhaust its ballast (i.e., drop all ballast) and reach its final pressure threshold (i.e., corresponding to a maximum altitude range for the vehicle indicated by cliff 414 at the tip of line 410) may be approximately equal to a desired lifetime input to fill and ballast tool 307.

Altitude range chart 450 similarly shows altitude ranges for a vehicle with a given base mass (e.g., approximately 135 kilograms) and a given ballast increment (e.g., 5 kilograms), wherein pre-flight ballast model 312 outputs a recommended optimal ballast amount (e.g., 30 kilograms), a recommended launch gas fill 466 (e.g., approximately 7,200 moles of helium), and altitude ranges for the vehicle at a range of lift gas amounts. Lines 452-464 represent resulting altitude ranges for the vehicle from a total system mass comprising the given base mass plus the recommended optimal ballast amount (line 452) to the given base mass after all ballast has been dropped (line 462), and each ballast drop at the given ballast increment in between. Cliff 464 indicates a final pressure threshold and a maximum altitude range for the vehicle.

Returning to FIG. 3, in-flight ballast model 414 may comprise an optimal ballast drop estimator configured to determine an optimal ballast drop amount and time based on a current actual or estimated system mass (e.g., based at least in part on an optimal ballast amount provided by pre-flight ballast model 312) and a remaining lift gas amount (e.g., derived from gas and air fill amounts from in-flight telemetry 316 and/or estimators, such as gas-air estimator 310). An optimal ballast drop time may further be based on one, or a combination, of a maximum average steering range (i.e., the range between a maximum superpressure threshold and a zero superpressure threshold) or probability of achieving a desired steering range (e.g., 90%, 95%, 97.5% or higher probability of achieving a maximum steering range), likelihood to zero pressure, and a predetermined buffer (i.e., to account for noise in measurements, as well as noise in estimates of remaining lift gas and other parameters). Since ballast cannot be reclaimed once dropped, in-flight ballast model 314 is configured to implement one or both of the following operational safeguards: (1) ballast is not dropped until a convergence criterion is met (e.g., a convergence of the modeled and estimated remaining lift gas), and (2) a target ballast amount (i.e., expected remaining ballast amount) for a given vehicle is shifted by a predetermined buffer (e.g., an incremental buffer amount of 1 kg, 2 kg, or more or less, based on a predetermined risk tolerance and results of simulations by the fill and ballast tool 307). In some examples, the predetermined buffer is based on statistical analysis of noise and oscillation data (e.g., actual historical data and/or simulated data) of lift gas estimates. Implementing one or both of these operational safeguards protects against early dropping of a ballast increment (e.g., prior to reaching one of ballast drop lift gas ranges 412). In some examples, a maximum ballast drop limit (e.g., for a vehicle and for a fleet, static or dynamic throughout a vehicle's lifetime) also may safeguard against outlier or erroneous estimates. Said maximum ballast drop limit may be a daily, weekly, monthly, lifetime or other periodic limit.

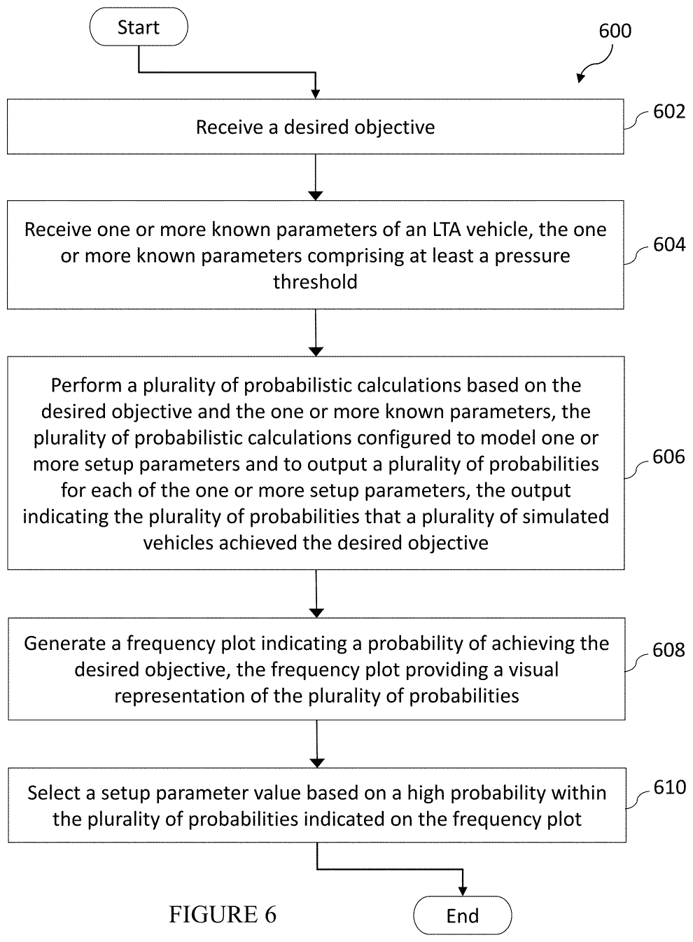

FIG. 6 is a flow diagram illustrating a method for achieving an objective for an LTA vehicle design, in accordance with one or more embodiments. Method 600 begins with receiving a desired objective at step 602. In some examples, the desired objective may comprise one or both of a desired lifetime and a desired altitude range. One or more known parameters of an LTA vehicle may be received at step 604, for example by a tool (e.g., one or more estimators and/or models) configured to perform probabilistic calculations (e.g., fill and ballast tool 307 in FIG. 3), the one or more known parameters comprising at least a pressure threshold (e.g., one or both of a burst pressure threshold and zero-pressure threshold). The one or more known parameters also may include vehicle parameters, setup parameters, or other parameters as described herein. A plurality of probabilistic calculations may be performed based on the desired objective and the one or more known parameters at step 606, the plurality of probabilistic calculations configured to model one or more setup parameters and to output a plurality of probabilities for each of the one or more setup parameters, the output indicating the plurality of probabilities that a plurality of simulated vehicles achieved the desired objective. In some examples, a frequency plot indicating a probability of achieving the desired objective may be generated at step 608, the frequency plot providing a visual representation of the plurality of probabilities. The frequency plot may indicate a range of probabilities of achieving the desired objective with the one or more setup parameters. A setup parameter value may be selected at step 610 based on a high probability (e.g., highest probability or exceeding a high probability threshold, such as 90%, 95%, 97.5% or higher) within the plurality of probabilities, which may be provided by the data output by the tool and indicated on the frequency plot.

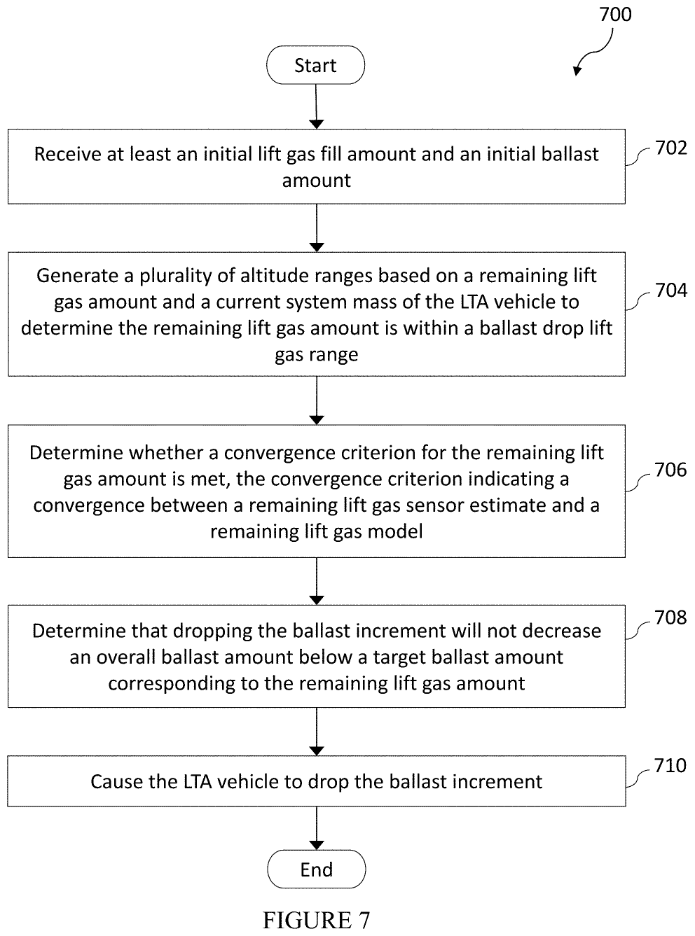

FIG. 7 is a flow diagram illustrating a method for automated ballast dropping by an LTA vehicle, in accordance with one or more embodiments. Method 700 may begin with receiving at least an initial lift gas fill amount (i.e., launch lift gas fill amount) and an initial ballast amount (i.e., optimal ballast amount) at step 702. In some examples, the initial lift gas fill amount and the initial ballast amount may be recommended or provided by a tool (e.g., fill and ballast tool 307 in FIG. 3) configured to perform probabilistic calculations (e.g., Monte Carlos) and to output recommended setup parameters, as described herein. An altitude range estimator (e.g., altitude range estimator 308 in FIG. 3, a separate altitude range estimator that is part of in-flight ballast model 314) may be configured to generate a plurality of altitude ranges based on a remaining lift gas amount and a current system mass of the LTA vehicle to determine if the remaining lift gas amount is within a ballast drop lift gas range, at step 704. In some examples, this step may comprise comparing the plurality of altitude ranges for a current system mass of the LTA vehicle with another plurality of altitude ranges for the current system mass minus a ballast increment, as described herein. A determination may be made whether a convergence criterion is met for the remaining lift gas amount at step 706, the convergence criterion indicating a convergence between a remaining lift gas estimate and a remaining lift gas model. A determination may be made that dropping the ballast increment will not decrease an overall ballast amount below a target ballast amount corresponding to the remaining lift gas amount at step 708. In some examples, a determination also may be made that dropping a ballast increment will not exceed a maximum ballast drop limit (not shown). In some examples, the remaining lift gas amount and/or time at which to drop ballast also may be based on one, or a combination, of a desired steering range (e.g., represented as a maximum average steering range or probabilistic threshold of achieving a desired steering range) and/or likelihood to zero pressure. Once the convergence criterion is met and a determination is made that a ballast drop will not decrease the overall ballast amount below the target ballast amount, the LTA vehicle may be caused to drop the ballast increment at step 710. For example, in-flight ballast model may be configured to send a command, directly or indirectly, to the LTA vehicle to drop the ballast increment.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

What is claimed is:

1. A method for automated ballast dropping by an LTA vehicle in flight, the method comprising:
receiving, by an in-flight ballast model, at least an initial lift gas fill amount and an initial ballast amount;
generating a plurality of altitude ranges based on a remaining lift gas amount and a current system mass of the LTA vehicle to determine the remaining lift gas amount is within a ballast drop lift gas range;
determining, by the in-flight ballast model, whether a convergence criterion for the remaining lift gas amount is met, the convergence criterion indicating a convergence between a remaining lift gas estimate and a remaining lift gas model;
determining, by the in-flight ballast model, that dropping a ballast increment will not decrease an overall ballast amount below a target ballast amount corresponding to the remaining lift gas amount; and
causing the LTA vehicle to drop the ballast increment.

2. The method of claim 1, wherein generating the plurality of altitude ranges comprises performing a plurality of probabilistic calculations.

3. The method of claim 2, wherein the plurality of probabilistic calculations comprises a Monte Carlo simulation.

4. The method of claim 1, wherein generating the plurality of altitude ranges comprises modeling the plurality of altitude ranges based on the initial lift gas fill amount and the initial ballast amount.

5. The method of claim 1, wherein the plurality of altitude ranges further is based on an initial total mass of the LTA vehicle comprising a base mass and the initial ballast amount.

6. The method of claim 5, wherein the ballast drop lift gas range is based on a comparison between the plurality of altitude ranges for a current system mass of the LTA vehicle with another plurality of altitude ranges for the current system mass minus a ballast increment.

7. The method of claim 1, wherein the target ballast amount is shifted from a prior ballast amount by a predetermined amount based on statistical analysis of noise and oscillation data of lift gas amount estimates.

8. The method of claim 7, wherein the noise and oscillation data comprises actual historical data.

9. The method of claim 7, wherein the noise and oscillation data comprises simulated data.

10. The method of claim 1, further comprising determining that dropping the ballast increment will not exceed a maximum ballast drop limit.

11. The method of claim 11, wherein the maximum ballast drop limit comprises a daily limit.

12. The method of claim 11, wherein the maximum ballast drop limit comprises a vehicle-specific limit for the LTA vehicle.

13. The method of claim 11, wherein the maximum ballast drop limit comprises a fleet-wide limit for a fleet comprising the LTA vehicle.

14. The method of claim 1, wherein causing the LTA vehicle to drop the ballast increment comprises sending, by the in-flight ballast model, a command to the LTA vehicle.

15. A distributed computing system for automated ballast dropping by an LTA vehicle in flight, the system comprising:
one or more computers and one or more storage devices, the one or more storage devices storing instructions that when executed cause the one or more computers to implement processors configured to:
receive, by an in-flight ballast model, at least an initial lift gas fill amount and an initial ballast amount;
generate a plurality of altitude ranges based on a remaining lift gas amount and a current system mass of the LTA vehicle to determine whether the remaining lift gas amount is within a ballast drop lift gas range;
determine, by the in-flight ballast model, whether a convergence criterion for the remaining lift gas amount is met, the convergence criterion indicating a convergence between a remaining lift gas estimate and a remaining lift gas model;
determine, by the in-flight ballast model, that dropping a ballast increment will not decrease an overall ballast amount below a target ballast amount corresponding to the remaining lift gas amount; and
cause the LTA vehicle to drop the ballast increment.
